(19) United States
(12) Patent Application Publication
(10) Pub. No.: US 2013/0204544 A1
(43) Pub. Date: Aug. 8, 2013

(54) METHODS AND SYSTEMS FOR DETERMINING AIRSPEED OF AN AIRCRAFT

(71) Applicant: Jason Thomas, Savannah, GA (US)

(72) Inventor: Jason Thomas, Savannah, GA (US)

(73) Assignee: GULFSTREAM AEROSPACE CORPORATION, Savannah, GA (US)

(21) Appl. No.: 13/365,736

(22) Filed: Feb. 3, 2012

(51) Int. Cl. G06F 19/00; G01L 3/04; G01P 5/00

(52) U.S. Cl. 702/41; 702/144

(57) ABSTRACT

The disclosed embodiments relate to methods and systems for determining airspeed of an aircraft.

### TECHNICAL FIELD

Embodiments of the present invention generally relate to aircraft, and more particularly relate to methods and systems for determining airspeed of an aircraft.

### BACKGROUND OF THE INVENTION

When an aircraft is in flight, availability of airspeed data is critical and therefore it is necessary to have systems that can be used to measure airspeed. To measure airspeed data needed to determine an aircraft's airspeed, many aircraft employ a pitot-static system.

A pitot-static system generally has a pitot tube, a static port, and the pitot-static instruments. The pitot-static system is used to obtain pressures for interpretation by the pitot-static instruments. For example, this equipment measures the forces acting on a vehicle as a function of the temperature, density, pressure, and viscosity of the fluid in which it is operating. For example, an airspeed indicator is connected to both the pitot and static pressure sources. The difference between the pitot pressure and the static pressure is called “impact pressure”. The greater the impact pressure, the higher the airspeed reported.

Other instruments that might be connected can include air data computers, flight control computers, autopilots, flight data recorders, altitude recorders, cabin pressurization controllers, and various airspeed switches. For example, many modern aircraft use an air data computer (ADC) to calculate airspeed, rate of climb, altitude, and Mach number. In some aircraft, two ADCs receive total and static pressure from independent pitot tubes and static ports, and the aircraft's flight data computer compares the information from both computers and checks one against the other.

Failure of Pitot-Static Measurement Equipment

Although pitot-static equipment is normally reliable, errors in or absence of pitot-static system readings can be extremely dangerous since the information obtained from the pitot static system, such as airspeed or altitude, is often critical to a successful and safe flight.

Pitot-static systems and apparatus can fail for several different reasons.

One type of pitot-static system malfunction occurs when a pitot tube is blocked. A blocked pitot tube will cause the airspeed indicator to register a faulty or incorrect airspeed, such as an increase in airspeed when the aircraft climbs, even though actual airspeed is constant. This is caused by the pressure in the pitot-system remaining constant when the atmospheric pressure (and static pressure) is decreasing. In reverse, the airspeed indicator will show a decrease in airspeed when the aircraft descends. Another failure is a reading of zero airspeed, when in fact the airspeed is still ample, which can occur when the pitot tube becomes blocked or clogged but the static port remains clear. The pitot tube is susceptible to clogging by ice, water, insects, volcanic ash, bird strike or some other obstruction. For this reason, aviation regulatory agencies such as the Federal Aviation Administration (FAA) recommend checking the pitot tube for obstructions prior to any flight. To prevent icing, many pitot tubes are equipped with a heating element.

Another type of pitot-static system malfunction occurs when a static port is blocked. A blocked static port is a more serious situation because it affects all pitot-static instruments. One of the most common causes of a blocked static port is airframe icing. A blocked static port will cause the altimeter to freeze at a constant value, the altitude at which the static port became blocked. The vertical speed indicator will freeze at zero and will not change at all, even if vertical airspeed increases or decreases. The airspeed indicator will reverse the error that occurs with a clogged pitot tube and result in an airspeed that is less than it is actually is as the aircraft climbs. When the aircraft is descending, the airspeed will be over-reported. In most aircraft with unpressurized cabins, an alternative static source is available and toggled from within the cockpit of the airplane.

Inherent errors can affect different pitot-static equipment. For example, density errors affect instruments metering airspeed and altitude. This type of error is caused by variations of pressure and temperature in the atmosphere. Therefore, modern pitot-static systems will automatically correct for temperature and pressure variances from standard atmospheric conditions to ensure accurate airspeed data is presented.

Need For Backup Airspeed Measurement Sources

Many modern aircraft implement redundant pitot-static airspeed measurement equipment that can serve as a backup when the primary pitot-static measurement equipment experiences a fault condition or fails. For example, many large transport category aircraft include three very similar or identical pitot-static systems for redundancy.

While the FAA permits this configuration, one drawback of this approach is that the two redundant pitot-static airspeed measurement systems are susceptible to failing for the same reasons that caused the primary pitot-static measurement system to fault or fail. For instance, all three pitot-static measurement systems can fall prey to a common mode failure (e.g., blockage failure due to contamination by ice, volcano ash, bird strikes and/or pitot heater failure, etc.) and experience a fault or failure at the same time. Unfortunately, no other backup airspeed measurement system is available.

There is a need for improved backup/redundant systems and apparatus that can be used to provide airspeed measurements during flight of an aircraft in the event that the pitot-static airspeed measurement equipment experiences a fault or fails.

It would be desirable to provide a secondary or “backup” airspeed measurement source for use in emergencies (e.g., when a partial or complete failure of the primary airspeed measurement occurs). It would also be desirable if such secondary or “backup” airspeed measurement sources are not susceptible to the same modes of failure as the primary pitot-static system(s). Other desirable features and characteristics of the present invention will become apparent from the subsequent detailed description and the appended claims, taken in conjunction with the accompanying drawings and the foregoing technical field and background.

### SUMMARY

In one embodiment, a method is provided for determining airspeed of an aircraft that includes an air turbine system. The air turbine system includes a turbine having a propeller that is configured to rotate at an angular velocity as an aircraft moves through the air at an airspeed, and a shaft, coupled to the turbine, that also rotates at the angular velocity as the propeller rotates. In accordance with this method, a shaft output power signal is generated, and an airspeed output signal is computed based on the shaft output power signal and other information.

In another embodiment, a system is provided for determining airspeed of an aircraft. The system includes an air turbine system. The air turbine system includes a turbine having a propeller and a shaft. The propeller is configured to rotate at an angular velocity as the aircraft moves through the air at an airspeed, and the shaft rotates at the angular velocity as the propeller rotates. A shaft power determination module is configured to generate a shaft output power signal, and an airspeed computation module is configured to generate an airspeed output signal based on the shaft output power signal and other information.

In another embodiment, another method is provided for computing airspeed of an aircraft. The aircraft includes an air turbine system that includes a turbine having a propeller and a shaft coupled to the turbine. The propeller is configured to rotate at an angular velocity as the aircraft moves through the air at an airspeed. In accordance with the method, a blade angle of the propeller is measured, the static air pressure and the static air temperature are sensed, and an air density value is determined based on the sensed static air pressure and the sensed static air temperature. A rotational speed of the shaft is computed. Output power of the shaft is computed and used along with the rotational speed of the shaft, the measured blade pitch angle, and the air density value to compute the airspeed.

### DESCRIPTION OF THE DRAWINGS

Embodiments of the present invention will hereinafter be described in conjunction with the following drawing figures, wherein like numerals denote like elements, and

FIG. 1 is an exemplary perspective view of an aircraft that can be used in accordance with some of the disclosed embodiments.

FIG. 2 is a functional block diagram of a system implemented within an aircraft for acquiring airspeed data in accordance with an exemplary implementation of the disclosed embodiments.

FIG. 3 is a block diagram of a system for determining airspeed of an aircraft in accordance with one exemplary implementation of the disclosed embodiments.

FIG. 4 is a block diagram of a power converter and transducer portion of an electrical air turbine system and a shaft power determination module that can be implemented in the system of FIG. 3 in accordance with one exemplary implementation of the disclosed embodiments.

FIG. 5 is a block diagram of a power converter and transducer portion of a hydraulic air turbine system and a shaft power determination module that can be implemented in the system of FIG. 3 in accordance with another exemplary implementation of the disclosed embodiments.

FIG. 6 is a block diagram of a power converter and transducer portion of a generic air turbine system and a shaft power determination module that can be implemented in the system of FIG. 3 in accordance with one exemplary implementation of the disclosed embodiments.

FIG. 7 is a flow diagram that shows some of the processing steps in accordance with one exemplary implementation of an airspeed calculation method that can be executed by the airspeed computation module of FIG. 3 in accordance with an exemplary implementation of the disclosed embodiments.

FIG. 8 is a set of exemplary graphs that illustrate the power coefficient (Cₚ) to advance ratio (J) relationship for given blade angles.

### DESCRIPTION OF EXEMPLARY EMBODIMENTS

As used herein, the word “exemplary” means “serving as an example, instance, or illustration.” The following detailed description is merely exemplary in nature and is not intended to limit the invention or the application and uses of the invention. Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention, which is defined by the claims. Furthermore, there is no intention to be bound by any expressed or implied theory presented in the preceding technical field, background, brief summary or the following detailed description.

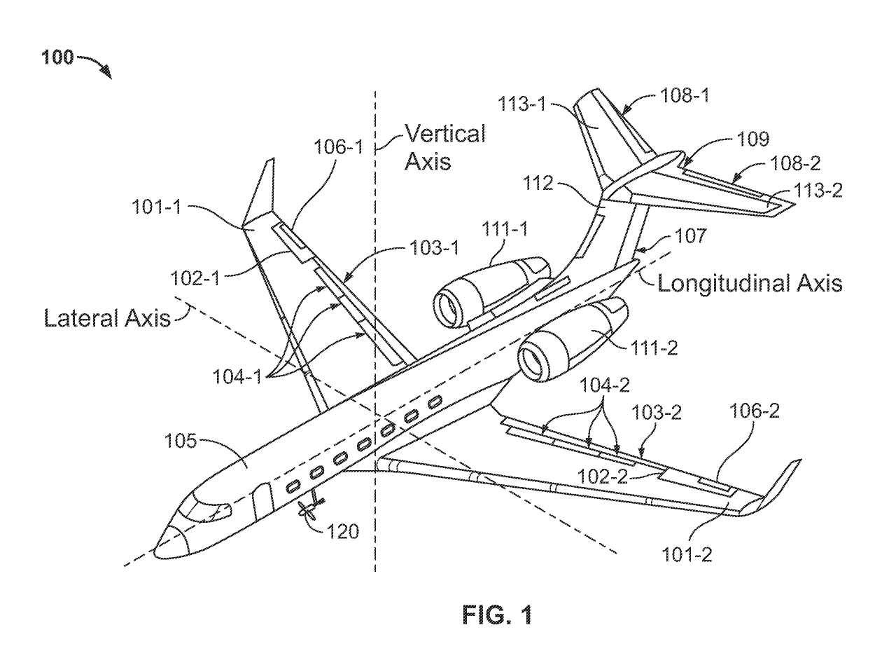

FIG. 1 is a perspective view of an aircraft 100 that can be used in accordance with some of the disclosed embodiments. In accordance with one non-limiting implementation of the disclosed embodiments, the aircraft 100 includes a fuselage 105, two main wings 101-1, 101-2, a vertical stabilizer 112, an elevator 109 that includes two horizontal stabilizers 113-1 and 113-2 in a T-tail stabilizer configuration, and two jet engines 111-1, 111-2. For flight control, the two main wings 101-1, 101-2 each have an aileron 102-1, 102-2, an aileron trim tab 106-1, 106-2, a spoiler 104-1, 104-2 and a flap 103-1, 103-2, while the vertical stabilizer 112 includes a rudder 107, and the aircraft's horizontal stabilizers (or tail) 113-1, 113-2 each include an elevator trim tab 108-1, 108-2. The aircraft 100 also includes at least one air turbine system 120 such as any ram air turbine system. The air turbine system 120 can be stowed within the aircraft, and deployed either manually or automatically so that at least a portion of it (including its propeller) extends external to the aircraft. Although not shown in FIG. 1, the aircraft 100 also includes an onboard computer, aircraft instrumentation and various control systems and sub-systems as will now be described with reference to FIG. 1.

The air turbine system 120 can employ any type of air turbine (e.g., ram air turbine). In general, an air turbine is a small turbine having a propeller with at least two blades. The diameter of the propeller can be greater than one meter in some implementations. The turbine can be connected to a power sink that receives power from the turbine shaft, such as a hydraulic pump, and/or an electrical generator. The air turbine is installed in or on an aircraft and used as a power source. To explain further, in normal conditions the air turbine is retracted into the fuselage (or wing). Following loss of power in the main engines and/or auxiliary power unit, the air turbine system 120 can be deployed so that its propeller extends outward from the aircraft to generate energy that can be used in emergencies to power vital systems (e.g., flight controls, linked hydraulics, flight-critical instrumentation). In some systems, batteries can be used to provide power until the air turbine is deployed either manually or automatically. The air turbine system 120 is located in a position to be exposed to sufficient, undisturbed, free-stream flow and can be located anywhere within the aircraft with its propeller extending outward from said position on the aircraft during deployment. The air turbine propeller is oriented so as to be aligned with the expected free-stream conditions during operation.

The air turbine generates power from the airstream due to the speed of the aircraft. For instance, in some implementations, the air turbine system 120 can produce electrical power via an electrical generator or hydraulic power via a hydraulic pump. In other implementations, the air turbine system 120 can produce hydraulic power, which is in turn used to power one or more electrical generators. The air turbine system 120 can implement any known air turbine including those supplied by Honeywell and Hamilton Sundstrand. A typical large air turbine on a commercial aircraft can be capable of producing, depending on the generator, from 5 to 70 kWatts. Smaller air turbines may generate as little as 400 watts.

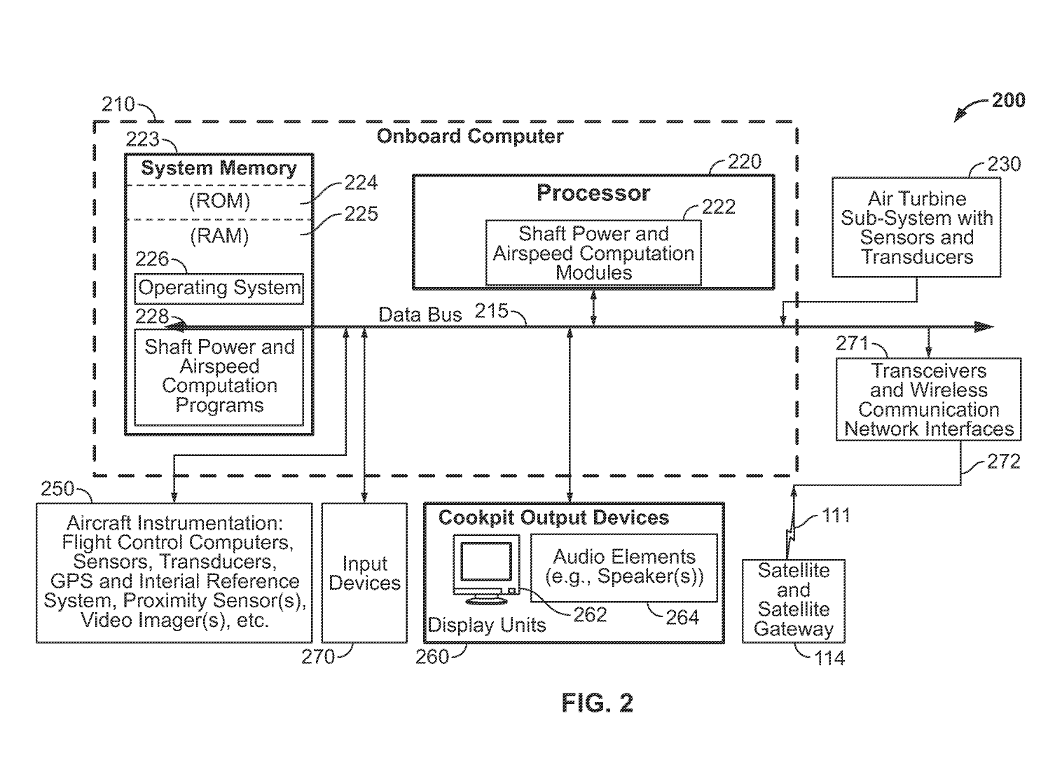

FIG. 2 is a block diagram of a system 200 implemented within an aircraft 100 for acquiring airspeed data in accordance with an exemplary implementation of the disclosed embodiments.

The system 200 includes an onboard computer 210, an air turbine system 230, aircraft instrumentation 250, cockpit output devices 260 (e.g., display units 262 such as control display units, multifunction displays (MFDs), etc., audio elements 264, such as speakers, etc.).

The aircraft instrumentation 250 can include, for example, flight control computers, sensors, transducers, elements of a Global Position System (GPS), which provides GPS information regarding the position and ground speed of the aircraft, autopilots, and elements of an Inertial Reference System (IRS), proximity sensors, switches, relays, video imagers, etc. In general, the IRS is a self-contained navigation system that includes inertial detectors, such as accelerometers, and rotation sensors (e.g., gyroscopes) to automatically and continuously calculate the aircraft's position, orientation, heading (direction) and velocity (speed of movement) without the need for external references once the IRS has been initialized. The IRS can include data supplied from pitot-static systems such as those described above to minimize inertial-based calculations.

The onboard computer system 210 includes a data bus 215, a processor 220, system memory 223, and satellite communication transceivers, and wireless communication network interfaces 271.

The data bus 215 serves to transmit programs, data, status and other information or signals between the various elements of FIG. 2. The data bus 215 is used to carry information communicated between the processor 220, the system memory 223, the air turbine system 230, aircraft instrumentation 250, cockpit output devices 260, various input devices 270, and the satellite communication transceivers and wireless communication network interfaces 271. The data bus 215 can be implemented using any suitable physical or logical means of connecting the on-board computer system 210 to at least the external and internal elements mentioned above. This includes, but is not limited to, direct hard-wired connections, fiber optics, and infrared and wireless bus technologies.

The processor 220 performs the computation and control functions of the on-board computer system 210, and may comprise any type of processor 220 or multiple processors 220, single integrated circuits such as a microprocessor, or any suitable number of integrated circuit devices and/or circuit boards working in cooperation to accomplish the functions of a processing unit.

It should be understood that the system memory 223 may be a single type of memory component, or it may be composed of many different types of memory components. The system memory 223 can include non-volatile memory (such as ROM 224, flash memory, etc.), memory (such as RAM 225), or some combination of the two. The RAM 225 can be any type of suitable random access memory including the various types of dynamic random access memory (DRAM) such as SDRAM, the various types of static RAM (SRAM). The RAM 225 includes an operating system 226, and data file generation programs 228.

The RAM 225 stores executable code for one or more shaft power and airspeed computation programs 228. The shaft power and airspeed computation programs 228 (stored in system memory 223) that can be loaded and executed at processor 220 to implement a shaft power and airspeed computation module 222 at processor 220. As will be explained below, the processor 220 executes the shaft power and airspeed computation programs 228 to generate a computed airspeed of the aircraft 100 that is computed based on information acquired from the air turbine system 230.

In addition, it is noted that in some embodiments, the system memory 223 and the processor 220 may be distributed across several different on-board computers that collectively comprise the on-board computer system 210.

The satellite communication transceivers and wireless communication network interfaces 271 are operatively and communicatively coupled to satellite antenna 272 that can be external to the on-board computer system 210. The satellite antenna 272 can be used to communicate information (i.e., receive information from or send information to) with a satellite 114 over satellite communication links 111. The satellite 114 can communicate information to or from a satellite gateway over other satellite communications links. The satellite gateway can be coupled to other networks (not illustrated), including the Internet, so that information can be exchanged with remote computers including a ground support network.

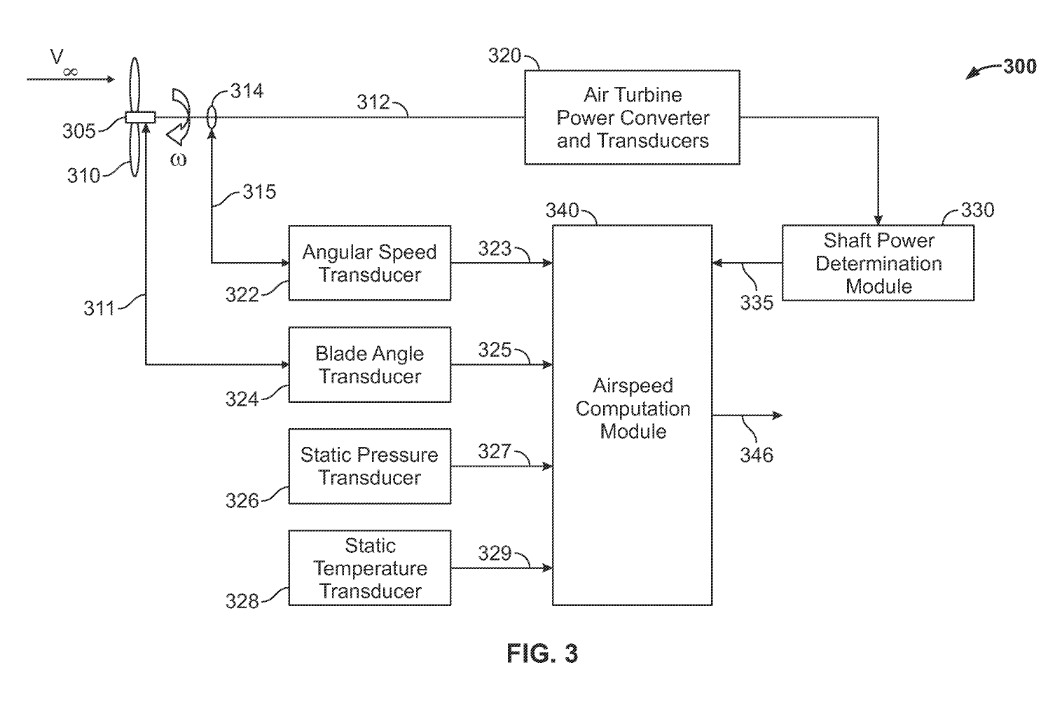

FIG. 3 is a block diagram of a system 300 for determining airspeed of an aircraft 100 in accordance with one exemplary implementation of the disclosed embodiments.

The system 300 includes an air turbine 305/310/312, an air turbine power converter and transducer(s) 320, a sensor 314, an angular speed transducer 322, a blade angle transducer 324, a static pressure transducer 326, a static air temperature transducer 328, a shaft power determination module 330, and an airspeed computation module 340.

The air turbine includes a turbine 305 having a propeller 310. The propeller 310 has at least two blades that define a propeller diameter (D). The turbine 305 is coupled to a shaft 312. As the aircraft moves through the air during flight, the propeller 310 rotates at an angular velocity, which causes the shaft 312 to also rotate and drive an electrical or hydraulic generator (not illustrated in FIG. 3).

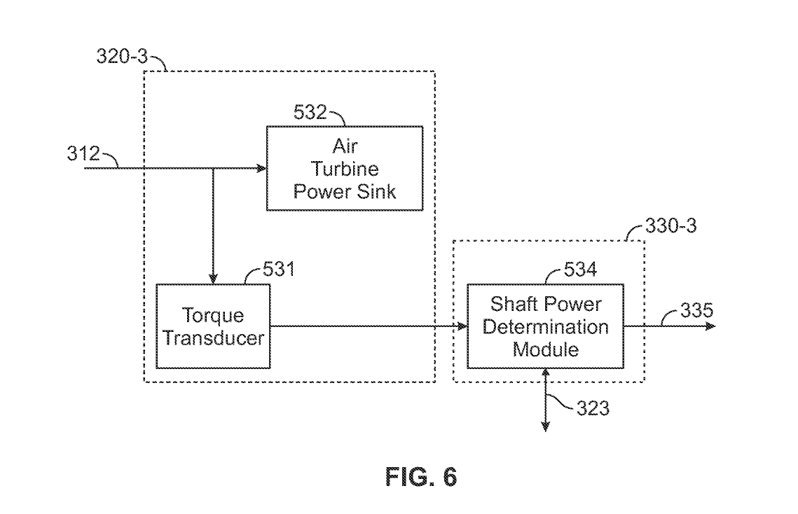

The sensor 314 is coupled to the shaft 312, and configured to measure an angular position of the shaft 312, or an angular speed at which the shaft 312 rotates, which depending on the implementation, can be in units of radians or degrees per unit time, or in units of revolutions per unit time. In the non-limiting description that follows, the sensor 314 generates a shaft angular velocity signal 315 in response to the rotation of the shaft 312; however, it is noted that in other implementations, the sensor 314 can also include the functionality of the angular speed transducer 322 such that the angular speed transducer 322 can be eliminated, and such that the sensor 314 outputs an angular velocity signal (ω) in radians or degree per unit time. Further, in some implementations, the sensor 314 can output an angular velocity signal (n) that is in revolutions per unit time, in which block 632 of FIG. 6 can also be eliminated. For instance, in some embodiments, the sensor 314 measures an angular velocity of the shaft in revolutions per unit time such as revolutions per minute or revolutions per second, and outputs a signal that can be directly used by the airspeed computation module 340 without further processing.

The air turbine power converter and transducer(s) 320 are generally shown in a block since the type of power converter and additional transducer(s) can vary depending on the implementation. For example, in one implementation, the power converter can be an electrical power generator and controls, and the additional transducers can include current, voltage and/or power sensors. In another implementation, the power converter can be a hydraulic power generator, and the additional transducers can include hydraulic pressure and flow transducers.

In this particular implementation, the angular speed transducer 322 is coupled to the sensor 314, and configured to receive signal 315. As the propeller 310 rotates, the angular speed transducer 322 generates a shaft angular velocity output signal 323 in response to signal 315. The shaft angular velocity output signal 323 can be in units of radians/degrees per unit time, or revolutions per unit time. In the later case, this allows block 632 of FIG. 6 to be eliminated.

The blade angle transducer 324 is coupled to the propeller 310. The blade angle transducer 324 is configured to measure a blade incidence or pitch angle 311 as the propeller 310 rotates, and to generate a blade angle output signal 325 in response to the measured blade incidence or pitch angle 311. For sake of clarity, the blade incidence angle is the angle of incidence of the mean aerodynamic chord of a blade, and is related to the pitch of a blade or propeller. As will be described below, this blade angle measurement is utilized in the blade pitch angle computation module 625.

The static pressure transducer 326 is configured to sense static pressure and to generate a static air pressure output signal 327 in response to the static pressure that is sensed. The static air temperature transducer 328 is configured to sense static air temperature and to generate a static air temperature output signal 329 in response to the static air temperature that is sensed.

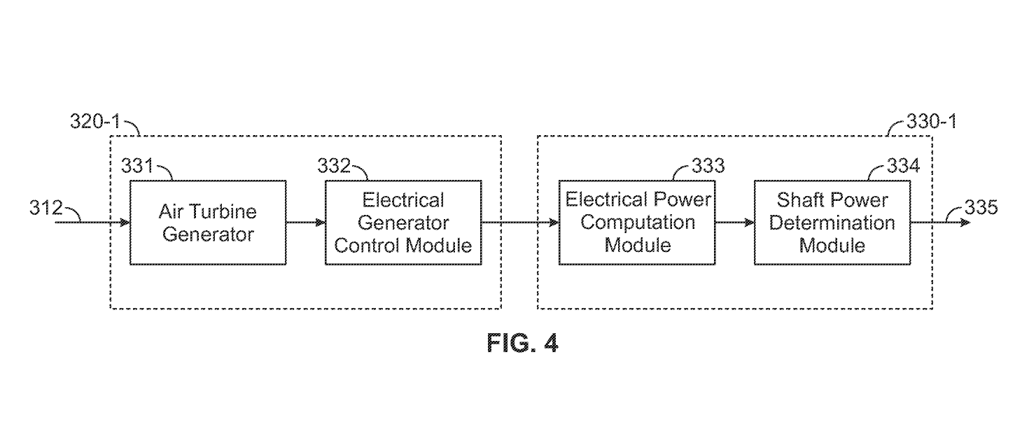

The shaft power determination module 330 includes measurement hardware and computation software that can be used to generate a shaft output power signal 335. The shaft output power signal 335 provides an indication of turbine power, and can be used along with other measured or sensed parameters and turbine configuration inputs (e.g., turbine shaft rotational speed, propeller diameter and blade angle) to generate a computed airspeed. The computed shaft power (Pₛ) output signal 335 can be directly measured or computationally determined Shaft power (Pₛ) can be expressed in Watts. Various implementations of the shaft power determination module 330 that can be used together or separately depending on the implementation will be described below with reference to FIGS. 4-6.

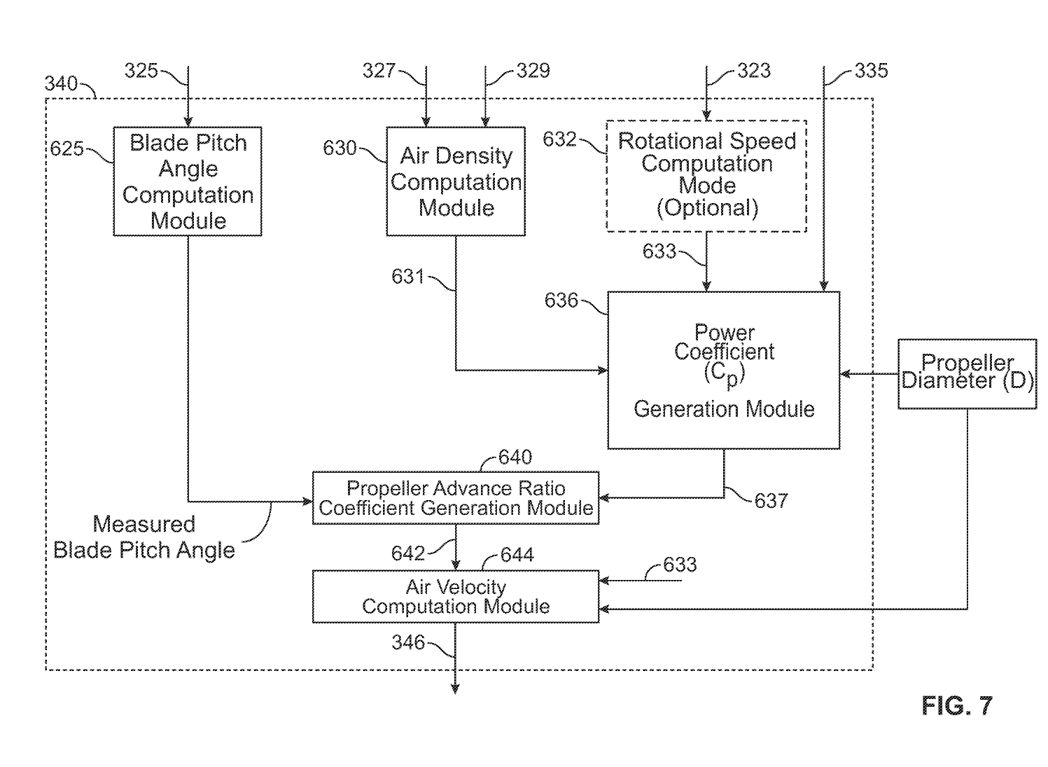

The airspeed computation module 340 generates an airspeed output signal 346 based on the shaft output power signal 335 and other inputs that include one or more of the shaft angular velocity output signal 323, the blade angle output signal 325, the static air pressure output signal 327, the static air temperature output signal 329. Depending on the implementation, the airspeed computation module 340 can be implemented using a relational algorithm or database between total power 355 and free-stream airspeed (V_{∝}) 346, which can be analytically and/or empirically determined based on the known concepts of classical propeller and blade-element momentum theory. One exemplary implementation of the airspeed computation module 340 will be described below with reference to FIG. 7.

FIG. 4 is a block diagram of a power converter and transducer portion 320-1 of an electrical air turbine system and a shaft power determination module 330-1 that can be implemented in the system 300 of FIG. 3 in accordance with one exemplary implementation of the disclosed embodiments.

In this embodiment, air turbine system is an electrical air turbine system air turbine power converter and transducer(s) 320-1 are implemented via an air turbine electrical generator 331 and an electrical generator control module 332 that can include additional transducers including current, voltage and/or power sensors. As will be described below, measured electrical power generation can be used to infer input shaft power provided from the turbine.

The air turbine electrical generator 331 is coupled to the shaft 312, and to the electrical generator control module 332. The shaft 312 rotates at an angular velocity (ω) as the propeller 310 rotates, which causes the air turbine electrical generator 331 to generate an electrical load output signal in response to rotation of the shaft 312.

Once the blade angle and rotational speed of the air turbine becomes sufficiently stabilized, the electrical generator control module 332 is configured to directly and continuously measure the electrical load output signal of the generator, to calculate measured electrical load, and to generate a measured electrical load in response to electrical load output signal. Alternatively, the generator load output can be measured by the aircraft emergency electrical bus (EBUS).

The shaft power determination module 330-1 includes an electrical power computation module 333 and a shaft power determination sub-module 334

The electrical power computation module 333 is coupled to the electrical generator control module 332. The electrical power computation module 333 is configured to generate an electrical power output signal based on the measured electrical load. For example, in one embodiment, the measured electrical load is current, and the electrical power computation module 333 is configured to continuously compute instantaneous electrical power (P_{E}) (typically expressed in Watts) to generate an electrical power output signal. In one implementation, this is done by computing the product of the measured current and voltage provided from the electrical generator control module 332.

The shaft power determination sub-module 334 is coupled to the electrical power computation module 333. The shaft power determination module 334 is configured to generate the shaft output power signal 335 based on the electrical power output signal from the electrical power computation module 333. For example, in one embodiment, the generalized turbine power input to the generator 331 can be determined from the relationship: P_{S}=P_{E}/ηₘ₋ₑ, where P_{S} is the instantaneous mechanical turbine shaft power input to the generator 331, P_{E} is the electrical power load from the generator and ηₘ₋ₑ is a mechanical-to-electrical power transfer efficiency factor. The instantaneous mechanical turbine shaft power (P_{S}) input to the generator 331 is directly related to the shaft power being generated by the turbine's propeller.

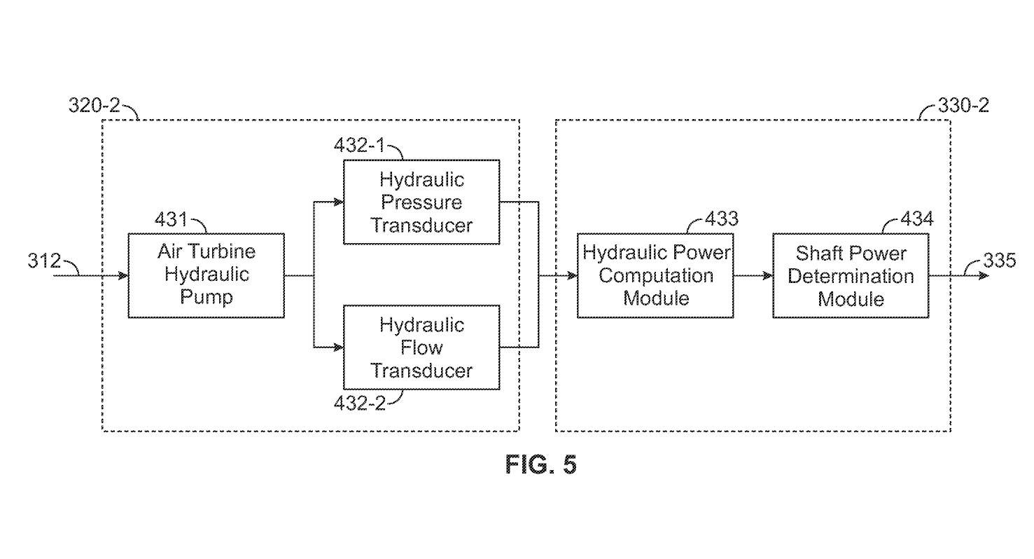

FIG. 5 is a block diagram of a power converter and transducer portion 320-2 of a hydraulic air turbine system and a shaft power determination module 330-2 that can be implemented in the system 300 of FIG. 3 in accordance with another exemplary implementation of the disclosed embodiments.

In this embodiment, air turbine system is hydraulic air turbine system and the air turbine power converter and transducer(s) 320-1 are implemented via an air turbine hydraulic pump 431 that is coupled to the propeller 310 via a shaft 312, a hydraulic pressure transducer 432-1 and a hydraulic flow transducer 432-2 coupled to the air turbine hydraulic pump 431. The shaft 312 rotates at an angular velocity (ω) as the propeller 310 rotates, which causes the air turbine hydraulic pump 431 to generate an air turbine hydraulic pump output in response to the rotation of the shaft 312. As will be described below, measured hydraulic power generation can be used to infer input shaft power provided from the turbine.

Once the blade angle and rotational speed of the hydraulic air turbine becomes sufficiently stabilized, air turbine pump output pressure and flow are measured. In one embodiment, the hydraulic pressure transducer 432-1 is configured to receive the air turbine hydraulic pump output and to generate a measured pressure output signal (p) in response to the air turbine hydraulic pump output. The hydraulic flow transducer 432-2 is configured to receive the air turbine hydraulic pump output and to generate a measured flow output signal (Q) in response to the air turbine hydraulic pump output.

The shaft power determination module 330-2 includes a hydraulic power computation module 433 and a shaft power determination sub-module 434.

The hydraulic power computation module 433 is coupled to the hydraulic pressure transducer 432-1 and the hydraulic flow transducer 432-2, and is configured to generate a hydraulic power load (P_{H}) output signal based on the measured pressure output signal (p) and the measured flow output signal (Q). In one embodiment, the hydraulic power computation module 433 determines the product of the measured pressure output signal and flow output signals to compute the hydraulic power load (P_{H}) output signal as follows:

P_{H}=p*Q,

where p is the hydraulic output pressure (typically in force per unit area, e.g., psi) and Q is the hydraulic flow from the hydraulic air turbine (typically measured in unit volume per unit time, e.g., in³/sec).

The shaft power determination sub-module 434 is coupled to the hydraulic power (P_{H}) computation module 433, and is configured to continuously generate the shaft output power signal 335 (that reflects instantaneous power) based on the hydraulic power load (P_{H}) output signal. For instance, in one embodiment, given the hydraulic power load (P_{H}) from the hydraulic pump, the generalized turbine power input to the pump can be determined from the relationship:

P_{S}=P_{H}/ηₘ₋ₕ,

where P_{S} is the instantaneous mechanical turbine shaft power input to the pump, which is directly related to the shaft power being generated by the propeller turbine, P_{H} is the hydraulic power, and ηₘ₋ₕ is the mechanical-to-hydraulic power transfer efficiency factor.

FIG. 6 is a block diagram of a power converter and transducer portion 320-3 of a generic air turbine system and a shaft power determination module 330-3 that can be implemented in the system 300 of FIG. 3 in accordance with one exemplary implementation of the disclosed embodiments.

In this embodiment, air turbine system can include any known air turbine (e.g., an electrical air turbine, a hydraulic air turbine, etc.). The power converter and transducer portion 320-3 is illustrated in FIG. 6 as a generic air turbine power sink 532 that is coupled to an air turbine via a shaft 312 (representative of a power generator that generates power as the shaft 312 rotates), and a torque transducer 531 coupled to the shaft 312. The torque transducer 531 can be implemented using strain-based instrumentation such as a strain gauge or other such device.

As the propeller 310 (FIG. 3) rotates, the shaft 312 rotates at an angular velocity (ω). The torque transducer 531 directly measures torque generated by the shaft 312, and outputs a shaft torque output signal that reflects the instantaneous torque generated by the shaft 312 as it rotates. The instantaneous torque generated by the shaft 312 is directly related to the power being generated by the propeller. Turbine shaft torque can be directly measured and used along with the shaft rotational velocity to infer input shaft power provided from the turbine.

The shaft power determination module 330-3 includes a shaft power determination sub-module 534 that is coupled to the torque transducer 531 and to the angular speed transducer 322 of FIG. 3. The power (Pₛ) generated is equal to the product of torque (T) and shaft rotational velocity (ω) in radians per unit time (e.g., rad/sec). The shaft power determination sub-module 534 can generate a computed shaft power (Pₛ) output signal 335 based on the product of the shaft angular velocity (ω) output signal 323 and the shaft torque (T) output signal as follows:

Pₛ=T*ω.

Rotational speed (n) in per unit time (e.g., revolutions per second or revolutions per minute) is related to the rotational velocity (ω) in radians per unit time by the relationship:

n=(2π*ω).

FIG. 7 is a flow diagram that shows some of the processing steps in accordance with one exemplary implementation of an airspeed calculation method that can be executed by the airspeed computation module 340 of FIG. 3 in accordance with an exemplary implementation of the disclosed embodiments. In one embodiment, the airspeed computation module 340 includes a blade pitch angle computation module 625, an air density computation module 630, a rotational speed computation module 632, a power coefficient generation module 636, a propeller advance ratio coefficient generation module 640, and an air velocity computation module 644.

The blade pitch angle computation module 625 computes a particular value of a measured blade pitch angle (αᵢ) based on a particular value of the blade angle output signal 325 from the blade angle transducer 324.

The air density computation module 630 computes a particular free-stream air density value 631 based on a particular value of the static air pressure output signal 327 and a particular value of the static air temperature output signal 329.

The rotational speed computation module 632 is optional and is employed in implementations where the output signal 323 is not in revolutions per unit time (e.g., when the output signal 323 is in units of radians per second or degrees per second, etc.) In such implementations, the rotational speed computation module 632 is configured to compute a particular value of a rotational speed 633 based on a particular value of the output signal 323. For example, in one implementation, the rotational speed computation module 632 computes the rotational speed (n) 633 per unit time (e.g., revolutions per second or revolutions per minute) based on the rotational velocity output signal (ω) 323 in radians per unit time as follows:

n=(2π*ω).

The power coefficient generation module 636 configured to determine a particular value of a power coefficient (Cₚ) 637 based on the particular air density (ρ) value 631, a particular value of the rotational speed (n) 633, a particular value of the computed shaft power (Pₛ) output signal 335, and the propeller diameter (D). The power coefficient (Cₚ) 637 is a non-dimensional coefficient that, for given inputs of αᵢ, ρ, n Pₛ, D creates a relational basis between power and Advance Ratio (J). For more information on propeller aerodynamics, please refer to Hartman, E. P., Biermann, D. “The Aerodynamic Characteristics of Full-Scale Propellers Having 2, 3 and 4 Blades of Clark Y and R.A.F 6 Airfoil Sections” NACA Technical Report 640, 1938.

Depending on the implementation, the power coefficient generation module 636 can determine a particular value of a power coefficient (Cₚ) 637 from an empirical database, from an algorithm, or by computing an equation. In one embodiment, the power coefficient generation module 636 configured to determine a particular value of a power coefficient (Cₚ) 637 per the following equation:

Cₚ=Pₛ/(ρn³D⁵).

The power coefficient (Cₚ) is a function of blade pitch angle and can be written as:

Cₚ(αᵢ).

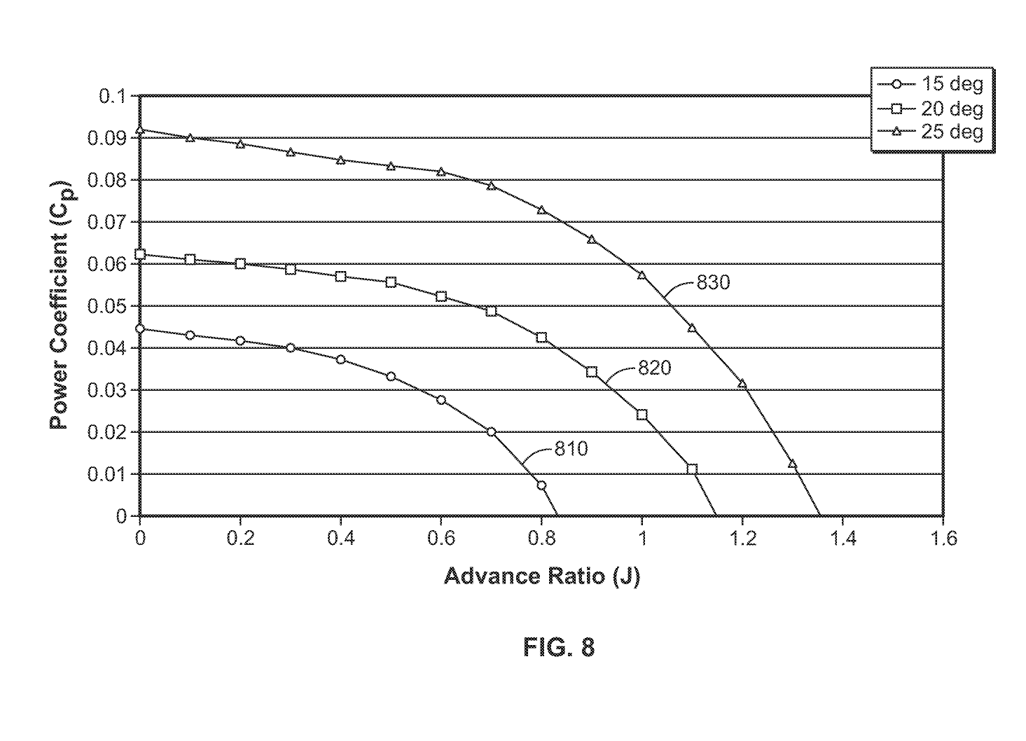

The propeller advance ratio coefficient generation module 640 can generate a particular value of a propeller advance ratio coefficient (J) 642 based on the particular value of the measured blade pitch angle (αᵢ) and the particular value of the power coefficient (Cₚ) 637. In other words, given the power coefficient (Cₚ) 637 and the particular value of the measured blade pitch angle (αᵢ), a fixed relation between the power coefficient Cₚ(αᵢ) as function of blade pitch angle (αᵢ) and the propeller's advance ratio coefficient (J) 642 can used to determine the value of advance ratio coefficient (J) 642 for a particular value of the power coefficient (Cₚ) 637 at a given blade pitch angle (αᵢ). FIG. 8 is a set of exemplary graphs that illustrate the power coefficient (Cp) as a function of advance ratio (J) for blade pitch angles of 15°, 20° and 25°. Other blade pitch angles could be considered or utilized, based on the operational envelope needed.

The air velocity computation module 644 configured to generate a particular instantaneous value of the airspeed output signal (V_{∞}) 346 based on the particular instantaneous value of the shaft rotational speed (n) 633 (in revolutions per unit time), the propeller diameter (D) (in length units), and the particular instantaneous value of a propeller advance ratio coefficient (J) 642. The propeller advance ratio coefficient (J) 642 is a non-dimensional coefficient that relates forward free-stream velocity with the product of the propeller's rotational speed and diameter as follows:

J=V_{∞}/(n*D)

In one embodiment, given the non-dimensional advance ratio coefficient (J) 642, then free-stream velocity (V_{∞}) 346 can be computed using the equation:

V_{∞}=n*D*J.

where n is the shaft rotational speed (in revolutions per unit time), D is the propeller diameter (in length units) and J is the advance ratio coefficient. The free-stream air velocity (V_{∝}) is typically expressed in speed per unit time, e.g., Knots-Calibrated Air Speed (KCAS) or Knots-True Air Speed (KTAS).

Thus, the disclosed embodiments can utilize the inherent features of an air turbine along with additional sensors to allow for calculation of free stream airspeed. This airspeed data can then be passed to the aircraft flight crew display for presentation.

One of the benefits of the disclosed embodiments is that they can be used to acquire airspeed when pitot-static measurement devices are unavailable. In one implementation, the systems and methods in accordance with the disclosed embodiments can be employed in an aircraft as a secondary or backup airspeed measurement source for use in emergency situations when primary pitot-static airspeed measurement systems experience a partial or complete failure. For example, in the event pitot sensors fail due to blockage or other reasons, the air turbine could be deployed to restore the airspeed data. The use of air turbine systems for determining airspeed is not subject to many of the same failure modes that the primary pitot-static airspeed measurement systems are subject to (e.g. , a blocked pitot port or pitot heater failure) since they do not rely on data from pitot-static probes.

Those of skill in the art would further appreciate that the various illustrative logical blocks/tasks/steps, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof

What is claimed is:

1. A method for determining airspeed of an aircraft that includes an air turbine system that includes a turbine having a propeller that is configured to rotate at an angular velocity (ω) as the aircraft moves through air at an airspeed, and a shaft coupled to the turbine that rotates at the angular velocity (ω) as the propeller rotates, the method comprising:
generating a shaft output power signal; and
computing an airspeed output signal based on the shaft output power signal and other information.

2. A method according to claim 1, wherein the step of computing comprises:
computing the airspeed output signal based on the shaft output power signal and the other information comprising at least one of a shaft angular velocity output signal, a blade angle output signal, a static air pressure output signal, and a static air temperature output signal.

3. A method according to claim 2, further comprising:
generating a shaft angular velocity output signal that corresponds to an angular speed at which the shaft rotates;
measuring a blade pitch angle of the propeller to generate the blade angle output signal;
sensing static pressure to generate the static air pressure output signal; and
sensing static air temperature to generate the static air temperature output signal.

4. A method according to claim 2, wherein the propeller has a propeller diameter, and
wherein the step of computing the airspeed output signal based on the shaft output power signal, comprises:
computing a particular value of a measured blade pitch angle based on a particular value of the blade angle output signal;
determining a particular air density value based on a particular value of the static air pressure output signal and a particular value of the static air temperature output signal;
computing a particular value of a rotational speed in revolutions per unit time based on a particular value of the shaft angular velocity output signal;
determining a particular value of a power coefficient based on the particular air density value, the particular value of the rotational speed, a particular value of the shaft output power signal, and the propeller diameter;
generating a particular value of a propeller advance ratio coefficient based on the particular value of the measured blade pitch angle and the particular value of the power coefficient; and
generating a particular value of the airspeed output signal based on the particular value of the rotational speed, the propeller diameter, and the particular value of the propeller advance ratio coefficient.

5. A method according to claim 1, wherein the air turbine system includes an air turbine electrical generator being configured to generate an electrical load output signal in response to rotation of the shaft, the air turbine electrical generator being coupled to the propeller via the shaft, the method further comprising:
measuring the electrical load output signal to generate a measured electrical load in response to the electrical load output signal; and
generating an electrical power output signal based on the measured electrical load; and
wherein the step of generating the shaft output power signal, comprises:
generating the shaft output power signal based on the electrical power output signal.

6. A method according to claim 1, wherein the air turbine system includes an air turbine hydraulic pump, coupled to the propeller via the shaft, and being configured to generate an air turbine hydraulic pump output in response to the rotation of the shaft, the method further comprising:
generating a measured pressure output signal and a measured flow output signal in response to the air turbine hydraulic pump output;
generating a hydraulic power load output signal based on the measured pressure output signal and the measured flow output signal; and
wherein the step of generating the shaft output power signal, comprises:
generating the shaft output power signal based on the hydraulic power load output signal.

7. A method according to claim 2, further comprising:
measuring torque generated by the shaft to generate a shaft torque output signal; and
wherein the step of generating the shaft output power signal, comprises:
generating the shaft output power signal based on the shaft angular velocity output signal and the shaft torque output signal.

8. A system for determining an airspeed of an aircraft, the system comprising:
an air turbine system that includes a turbine having a propeller that is configured to rotate at an angular velocity as the aircraft moves through air at the airspeed, and a shaft coupled to the turbine that rotates at the angular velocity (ω) as the propeller rotates;
a shaft power determination module configured to generate a shaft output power signal; and
an airspeed computation module configured to generate an airspeed output signal based on the shaft output power signal and other information.

9. A system according to claim 8, wherein the other information that comprises at least one of a shaft angular velocity output signal, a blade angle output signal, a static air pressure output signal, and a static air temperature output signal.

10. A system according to claim 9, further comprising:
a signal source that generates the shaft angular velocity output signal;
a blade angle transducer, coupled to a common blade pitch control shaft of the propeller, wherein the blade angle transducer is configured to measure a blade pitch angle and to generate the blade angle output signal;
a static pressure transducer configured to sense static pressure and to generate the static air pressure output signal in response to the static pressure that is sensed; and
a static air temperature transducer configured to sense static air temperature and to generate the static air temperature output signal in response to the static air temperature that is sensed.

11. A system according to claim 10, wherein the propeller has a propeller diameter, and the airspeed computation module comprises:
a blade pitch angle computation module configured to compute a particular value of a measured blade pitch angle based on a particular value of the blade angle output signal from the blade angle transducer;
an air density computation module configured to determine a particular air density value based on a particular value of the static air pressure output signal and a particular value of the static air temperature output signal;
a rotational speed computation module configured to compute a particular value of a rotational speed in revolutions per unit time based on a particular value of the shaft angular velocity output signal in radians per unit time;
a power coefficient generation module configured to determine a particular value of a power coefficient based on the particular air density value, the particular value of the rotational speed, a particular value of the shaft output power signal, and the propeller diameter;
a propeller advance ratio coefficient generation module configured to generate a particular value of a propeller advance ratio coefficient based on the particular value of the measured blade pitch angle and the particular value of the power coefficient; and
an air velocity computation module configured to generate a particular value of the airspeed output signal based on the particular value of the rotational speed, the propeller diameter, and the particular value of the propeller advance ratio coefficient.

12. A system according to claim 8, wherein the air turbine system includes an air turbine electrical generator, coupled to the propeller via the shaft, and being configured to generate an electrical load output signal in response to rotation of the shaft; and
further comprising:
an electrical generator control module, coupled to the air turbine electrical generator, and being configured to measure the electrical load output signal and to generate a measured electrical load in response to the electrical load output signal, and
wherein the shaft power determination module comprises:
an electrical power computation module, coupled to the electrical generator control module, wherein the electrical power computation module is configured to generate an electrical power output signal based on the measured electrical load; and
a shaft power determination sub-module, coupled to the electrical power computation module, wherein the shaft power determination sub-module is configured to generate the shaft output power signal based on the electrical power output signal.

13. A system according to claim 8, wherein the air turbine system includes: an air turbine hydraulic pump, coupled to the propeller via the shaft, and being configured to generate an air turbine hydraulic pump output in response to the rotation of the shaft; and
further comprising:
a hydraulic pressure transducer, coupled to the air turbine hydraulic pump, wherein the hydraulic pressure transducer is configured to receive the air turbine hydraulic pump output and to generate a measured pressure output signal in response to the air turbine hydraulic pump output;
a hydraulic flow transducer, coupled to the air turbine hydraulic pump, wherein the hydraulic flow transducer is configured to receive the air turbine hydraulic pump output and to generate a measured flow output signal in response to the air turbine hydraulic pump output;
wherein the shaft power determination module comprises:
a hydraulic power computation module, coupled to the hydraulic pressure transducer and the hydraulic flow transducer, wherein the hydraulic power computation module is configured to generate a hydraulic power load output signal based on the measured pressure output signal and the measured flow output signal; and
a shaft power determination sub-module, coupled to the hydraulic power computation module, wherein the shaft power determination sub-module is configured to generate the shaft output power signal based on the hydraulic power load output signal.

14. A system according to claim 10, further comprising:
a torque transducer, coupled to the propeller via the shaft, the torque transducer being configured to measure torque generated by the shaft, and to generate a shaft torque output signal in response to the torque generated by the shaft;
wherein the shaft power determination module comprises:
a shaft power determination sub-module, coupled to the torque transducer and the angular speed transducer, wherein the shaft power determination sub-module is configured to generate the shaft output power signal based on the shaft angular velocity output signal and the shaft torque output signal.

15. A method for computing airspeed of an aircraft that includes an air turbine system that includes a turbine having a propeller that is configured to rotate at an angular velocity as the aircraft moves through air at an airspeed, and a shaft coupled to the turbine, the method comprising:
measuring a blade pitch angle of the propeller;
sensing a static air pressure and a static air temperature;
determining an air density value based on the static air pressure and the static air temperature;
measuring an angular speed at which the shaft rotates and computing a rotational speed of the shaft;
computing a shaft output power; and
computing the airspeed based on the shaft output power, the rotational speed of the shaft, a measured blade pitch angle, and the air density value.

16. A method according to claim 15, wherein the step of computing the airspeed comprises:
determining a power coefficient based on the air density value, the rotational speed of the shaft, the shaft output power, and a propeller diameter of the propeller;
generating a propeller advance ratio coefficient based on the measured blade pitch angle and the power coefficient; and
computing the airspeed of the aircraft based on the rotational speed, the propeller diameter, and the propeller advance ratio coefficient.

17. A method according to claim 15, wherein the air turbine system includes an air turbine electrical generator coupled to the propeller via the shaft and being configured to generate an electrical load output in response to rotation of the shaft, the method further comprising:
measuring the electrical load output and generating an electrical power output; and
wherein the step of computing the shaft output power, comprises:
computing a shaft output power signal based on the electrical power output.

18. A method according to claim 15, wherein the air turbine system includes an air turbine hydraulic pump, coupled to the propeller via the shaft, and being configured to generate an air turbine hydraulic pump output in response to the rotation of the shaft, the method further comprising:
measuring a pressure output and a flow output of the air turbine hydraulic pump output; and
generating a hydraulic power load output based on the wherein the step of computing the shaft output power, comprises:
computing the shaft output power based on the hydraulic power load output.

19. A method according to claim 15, the method further comprising:
measuring torque generated by the shaft; and
wherein the step of computing the shaft output power, comprises:
computing the shaft output power based on the angular speed of the shaft and a torque generated by the shaft.
